(19) United States
(12) Patent Application Publication
(10) Pub. No.: US 2012/0137988 A1
(43) Pub. Date: Jun. 7, 2012

(54) CONTROL LEASH AND METHOD OF USE

(76) Inventor: DAMON K.I. KALI, Sunnyvale, CA (US)

(21) Appl. No.: 13/307,934

(22) Filed: Nov. 30, 2011

Related U.S. Application Data
(60) Provisional application No. 61/420,616, filed on Dec. 7, 2010.

(51) Int. Cl. A01K 27/00

(52) U.S. Cl. 119/795

(57) ABSTRACT

Leashes are presented including: an elongated lead having, a proximal end portion, a distal end portion and a length defined there between; a fixed handle disposed at the proximal end portion, where the fixed handle is constructed and arranged to receive a handler's first hand; a collar attachment mechanism disposed at the distal end portion; and a sliding handle slidingly attached along the length of the elongated lead thereof by a sliding mechanism such that the sliding handle is configured to freely move along the length of the elongated lead, where the sliding handle is configured to maintain an open loop, the open loop arranged to receive a handler's second hand.

### PRIORITY CLAIM TO PROVISIONAL APPLICATION

A claim for priority is hereby made under the provisions of 35 U.S.C. §119 for the present application based upon U.S. Provisional Application filed on Dec. 7, 2010 and assigned Ser. No. 61/420,616, which is incorporated herein by reference.

### BACKGROUND

The primary function of a leash is to control an animal. Many variations of leashes are available for controlling and training an animal. Recently, retractable leashes have allowed handlers to let an animal track a short distance from the handler. In some examples, retractable leashes may provide up to 25 feet of leash. These leashes are particularly useful when training an animal to track other animals. They may also be useful in large fields where there is adequate space for an animal to wander.

However, retractable leashes are typically not configured to provide rapid control of an animal by shortening of the leash. This is particularly true when an animal is struggling to move away from a handler to an attractive target. Retractable leashes, in this instance, may require a handler to grab a portion of the leash and pull the leash toward the handler, which may, in some examples, cause injury to the handler due to leash slippage. Additionally, the use of long leashes provided by retractable leashes may lead to excess tangling and knotting especially for active animals. As such, leashes are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Leashes are presented including: an elongated lead having, a proximal end portion, a distal end portion and a length defined there between; a fixed handle disposed at the proximal end portion, where the fixed handle is constructed and arranged to receive a handler's first hand; a collar attachment mechanism disposed at the distal end portion; and a sliding handle slidingly attached along the length of the elongated lead thereof by a sliding mechanism such that the sliding handle is configured to freely move along the length of the elongated lead, where the sliding handle is configured to maintain an open loop, the open loop arranged to receive a handler's second hand. In some embodiments, leashes further include: a holding element disposed proximate to the fixed handle along the length of the elongated lead for temporarily affixing the sliding handle proximate to the fixed handle; and an upper slide stop disposed proximately with the holding element along the length of the elongated lead configured to align the sliding handle with the holding element. In some embodiments, leashes further include: a lower slide stop disposed proximately with the collar attachment mechanism along the length of the elongated lead configured to temporarily secure the sliding handle proximate to the collar attachment mechanism. In some embodiments, leashes further include: an intermediate slide stop disposed along the length of the elongated lead configured to temporarily secure the sliding handle in an intermediate position along the elongated lead.

In other embodiments, leashes are presented including: an elongated lead . having, a proximal end portion, a distal end portion and a length defined there between; a fixed handle disposed at the proximal end portion, where the fixed handle is constructed and arranged to receive a handler's first hand; a collar attachment mechanism disposed at the distal end portion; a sliding handle slidingly attached along the length of the elongated lead thereof by a sliding mechanism such that the sliding handle is configured to freely move along the length of the elongated lead, where the sliding handle includes at least one semi-rigid member configured to maintain an open loop, the open loop arranged to receive a handler's second hand; a holding element disposed proximate to the fixed handle along the length of the elongated lead for temporarily affixing the sliding handle proximate to the fixed handle; an upper slide stop disposed proximately with the holding element along the length of the elongated lead configured to align the sliding handle with the holding element; and a lower slide stop disposed proximately with the collar attachment mechanism along the length of the elongated lead configured to temporarily secure the sliding handle proximate to the collar attachment mechanism. In some embodiments, leashes further include: an intermediate slide stop disposed along the length of the elongated lead configured to temporarily secure the sliding handle in an intermediate position along the elongated lead.

In other embodiments, methods for utilizing a leash are presented including: attaching an animal to the leash, where the animal is attached to the leash by a collar attachment mechanism, where the collar attachment mechanism is attached at a distal end portion of an elongated lead of the leash, and where the collar attachment mechanism includes a swivel arrangement for allowing the collar to freely rotate with respect to the elongated lead handling the animal utilizing a fixed handle disposed at a proximal end portion of the elongated lead and constructed and arranged to receive a handler's first hand; and closely controlling the animal by grasping a sliding handle initially disposed at the proximal end portion and moving the sliding handle to the distal end portion such that the animal is closely controlled by a handler, where the sliding handle is configured to freely move along the elongated lead, and where the sliding handle is configure to maintain an open loop. In some embodiments, methods further include: temporarily securing the sliding handle proximate to the collar attachment mechanism by moving the sliding handle past a lower slide stop, where the lower slide stop is configured to allow the sliding handle to move freely toward the collar attachment mechanism and to temporarily secure the sliding handle from moving toward the fixed handle. In some embodiments, methods further include: temporarily affixing the sliding handle proximate to the fixed handle by moving the sliding handle toward the fixed handle to an upper slide stop and affixing the sliding handle to a holding element disposed proximate to the fixed handle. In some embodiments, methods further include: temporarily securing the sliding handle in an intermediate position along the elongated lead by moving the sliding handle along the elongated lead past an intermediate slide stop, where the intermediate slide stop is configured to allow the sliding handle to move freely toward the collar attachment mechanism and to temporarily secure the sliding handle from moving toward the fixed handle.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a leash in accordance with embodiments of the present invention;

FIG. 2 is an illustrative representation of upper slide stops in accordance with embodiments of the present invention;

FIG. 3 is an illustrative representation of sliding handles in accordance with embodiments of the present invention;

FIG. 4 is an illustrative representation of a sliding handle having a holding element in accordance with embodiments of the present invention;

FIG. 5 is an illustrative representation of a leash having a handle cinch arrangement in accordance with embodiments of the present invention;

FIG. 6 is an illustrative representation of lower slide stops in accordance with embodiments of the present invention; and

FIG. 7 is an illustrative representation a leash in use in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

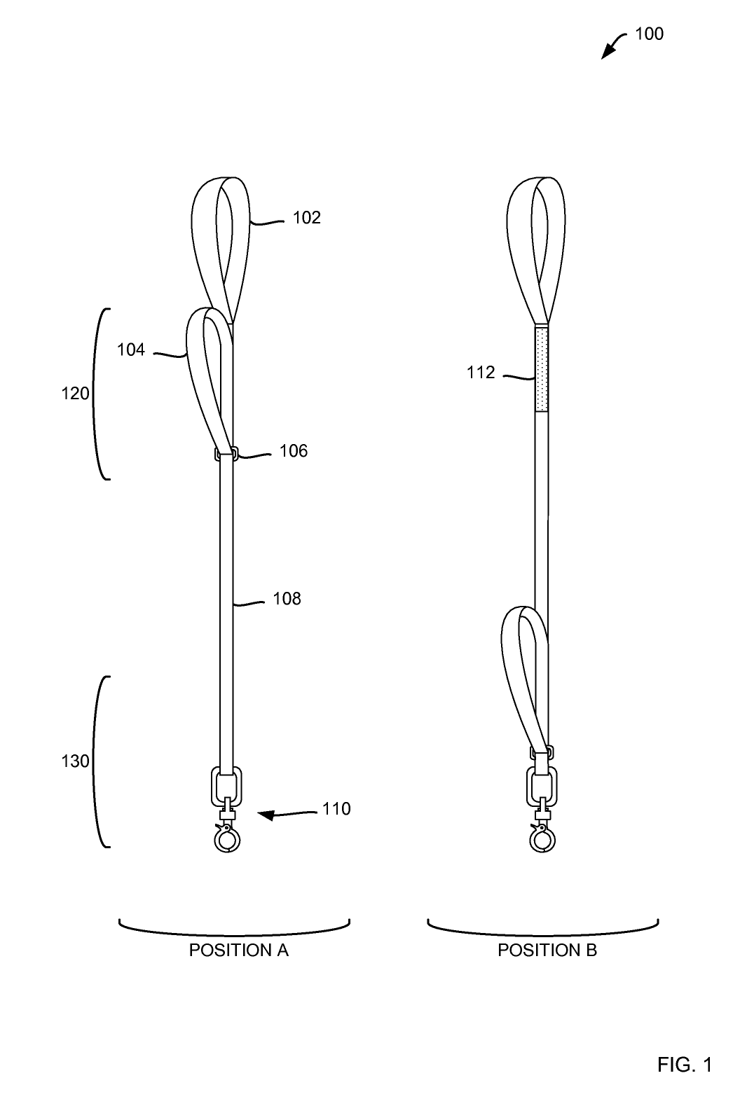

FIG. 1 is an illustrative representation of a leash 100 in accordance with embodiments of the present invention. In particular, leash 100 includes fixed handle 102 disposed along proximal end 120 of elongated lead 108. In embodiments, fixed handles may include an open loop of leash material or any other handle configuration known in the art without departing from embodiments herein. Leash 100 further includes collar attachment mechanism 110 disposed along distal end 130 of elongated lead 108. In embodiments, collar attachment mechanisms may include a swivel arrangement for allowing the collar to freely rotate with respect to elongated leads. In one embodiment, leash 100 may further include sliding handle 104 configured to be disposed intermediate either proximal end 120 or distal end 130. In another embodiment, sliding handle 104 may be configured to be disposed at an intermediate position along elongated lead 108 (not shown). In position A, sliding handle 104 may be temporarily affixed proximate to fixed handle 102 utilizing holding element 112. In embodiments, holding elements may include a hook and loop arrangement, a VELCRO™ arrangement, a snap arrangement, a magnetic strip arrangement, and a clasping arrangement.

When leash 100 is disposed as illustrated in position A, when an animal is secured to collar attachment mechanism 110, a handler's hand may be received by fixed handle 102. In this manner, leash 100 functions much like conventional fixed length leashes. However, in position B, sliding handle 104 may be translated proximate to collar attachment mechanism 110 by a handler's second hand. In this manner, leash 100 may be immediately and effectively shortened in order to closely control an animal. In some prior art systems, a second handle may be located along a length of leash such as in U.S. Pat. No. 7,743,735. However, in those systems, second handles cannot be freely moved to immediately and effectively control an animal.

In embodiments, sliding handle 104 may be configured to freely move along elongated lead 108. Free movement may be accomplished via sliding mechanism 106. In some embodiments, sliding mechanism is a ring. In some embodiments, rings may be configured in an annular shape such as: a circular shape, an ovate shape, a semi-ovate shape, a triangular shape, a rectangular shape, and a semi-rectangular shape. In some embodiments, leash 100 may be manufactured from various materials such as a natural fiber strap, a polymeric fiber strap, a leather strap, a natural fiber rope, a polymeric rope, a leather rope, a metal rope, a cable, a natural fiber hollow tube strap, a polymeric fiber hollow tube strap and a metal chain.

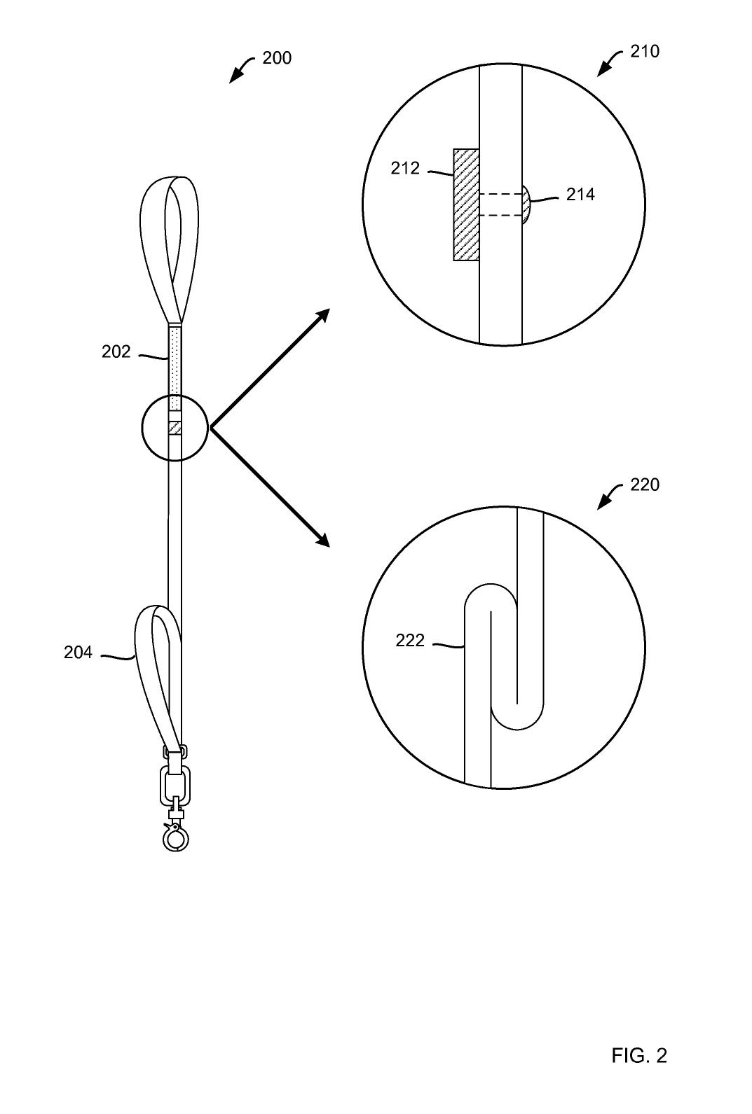

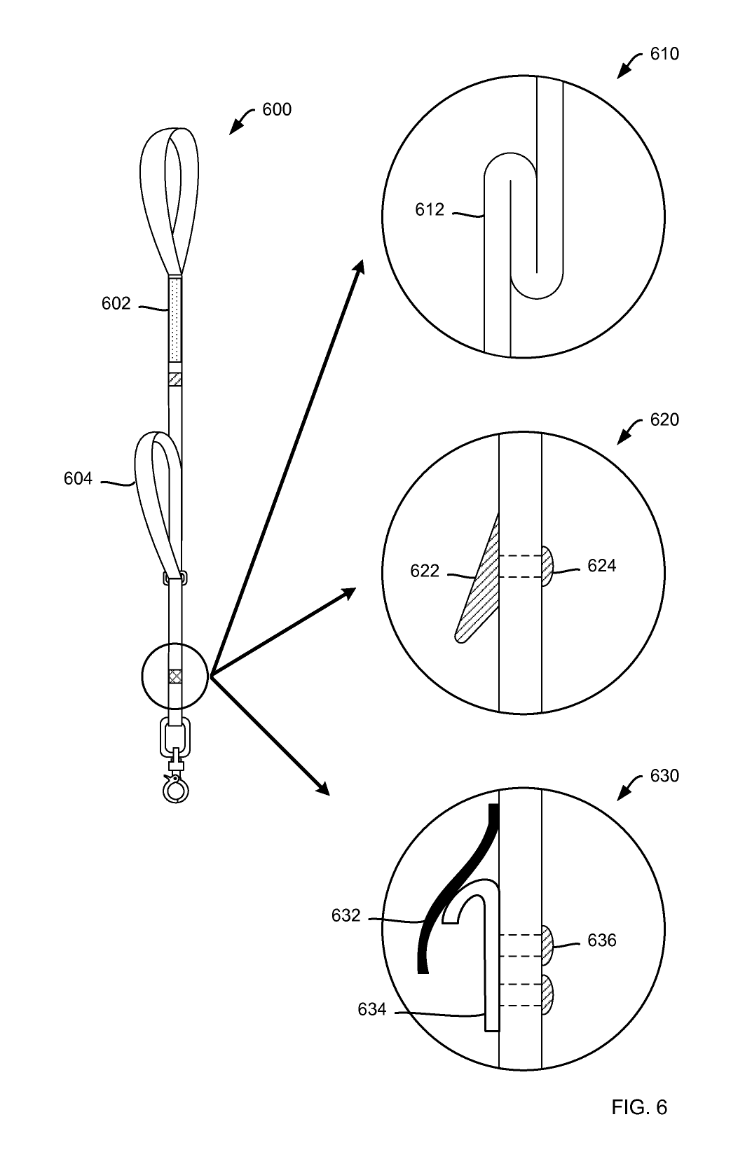

FIG. 2 is an illustrative representation of upper slide stops in accordance with embodiments of the present invention. In embodiments, leash 200 may include any number of types of slides stops for aligning sliding handle 204 with respect to holding element 202. In one embodiment upper slide stop 210 may include stop element 212 mechanically coupled with elongated lead by fastening element 214. In some embodiments, stop elements may be located on both sides of elongated strap (not shown). In embodiments stop elements may include button arrangements and washer arrangements of any appropriate shape or size. In some embodiments, fastening elements may include bolts, rivets, screws and any other fastening element known in the art. In some embodiments, stop elements may be bonded with elongated leads by welding, gluing, taping, sewing, or any other method known in the art without departing from embodiments provided herein. In another embodiment, upper slide stop 220 may include a multifold arrangement 222 of elongated strap. Multifold arrangements, as contemplated herein, include at least two folds of an elongated lead where the folds are folded back along the elongated lead to create a slide stop. Advantageously, a slide stop utilizing a multifold arrangement provides for a sliding arrangement to move in one direction of pull freely, while providing a stop for a sliding arrangement in an opposite direction of pull. Multifold arrangement will be described in further detail below for FIG. 6. Multifold arrangements may be secured welding, gluing, taping, sewing, bolting, riveting, screwing, or any other manner known in the art without departing from embodiments herein.

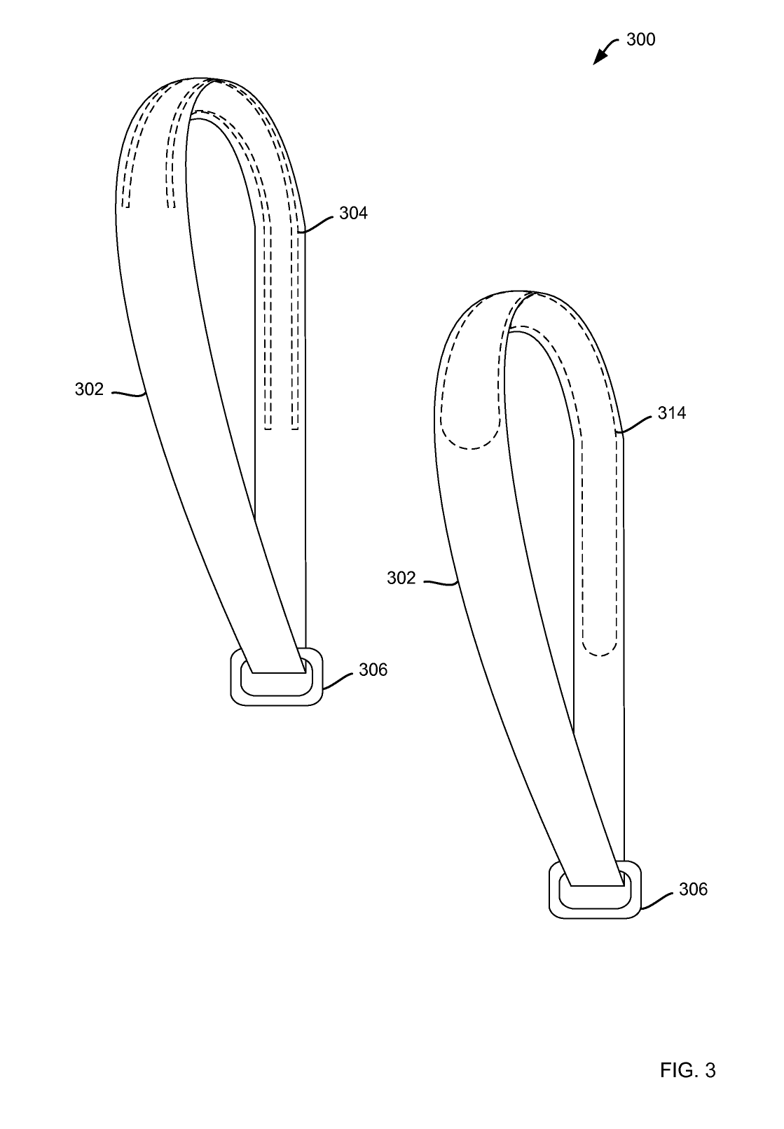

FIG. 3 is an illustrative representation of sliding handles 300 in accordance with embodiments of the present invention. In some embodiments, sliding handle 302 may include one 314 or more 304 semi-rigid members configured to maintain an open loop arranged to receive a handler's second hand. In some embodiments, any chemical stiffening agent well known in the art, such as a starch or glue may be utilized to maintain an open loop. At least one reason for maintaining an open loop is to facilitate a handler's ability to effectively engage sliding handle 302. As may be appreciated, effectively controlling an animal may require split second reactions. An open loop provides an easily graspable element so that a handler may react quickly and effectively. In contrast, a floppy loop might slow effective reaction time in some examples. As noted above, free movement along an elongated lead may be accomplished via sliding mechanism 306. In some embodiments, sliding mechanism is a ring. In some embodiments, rings may be configured in an annular shape such as: a circular shape, an ovate shape, a semi-ovate shape, a triangular shape, a rectangular shape, and a semi-rectangular shape.

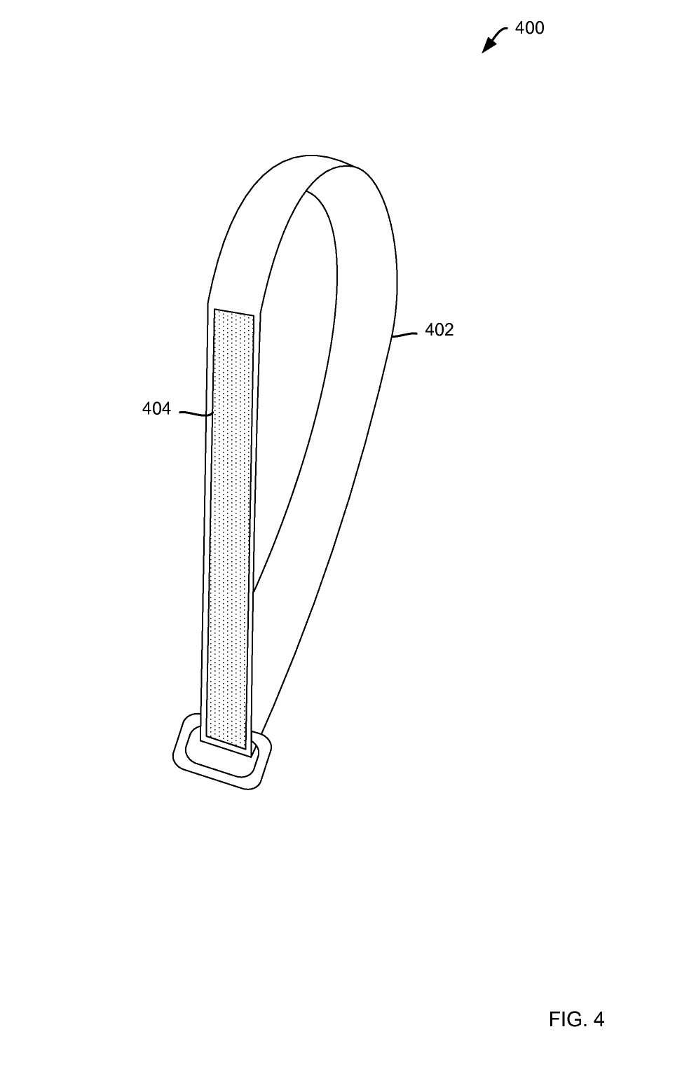

FIG. 4 is an illustrative representation of a sliding handle 400 having a holding element in accordance with embodiments of the present invention. In embodiments, sliding handle 402 may include holding element 404 for temporarily affixing the sliding handle proximate to the fixed handle (see FIG. 1, 112). Use of a holding element, in some embodiments, secures a sliding handle in an easily reachable position. In utilizing a hook and loop arrangement, sliding handles may be easily utilized and subsequently secured. As noted above, in embodiments, holding elements may include a hook and loop arrangement, a VELCRO™ arrangement, a snap arrangement, a magnetic strip arrangement, and a clasping arrangement.

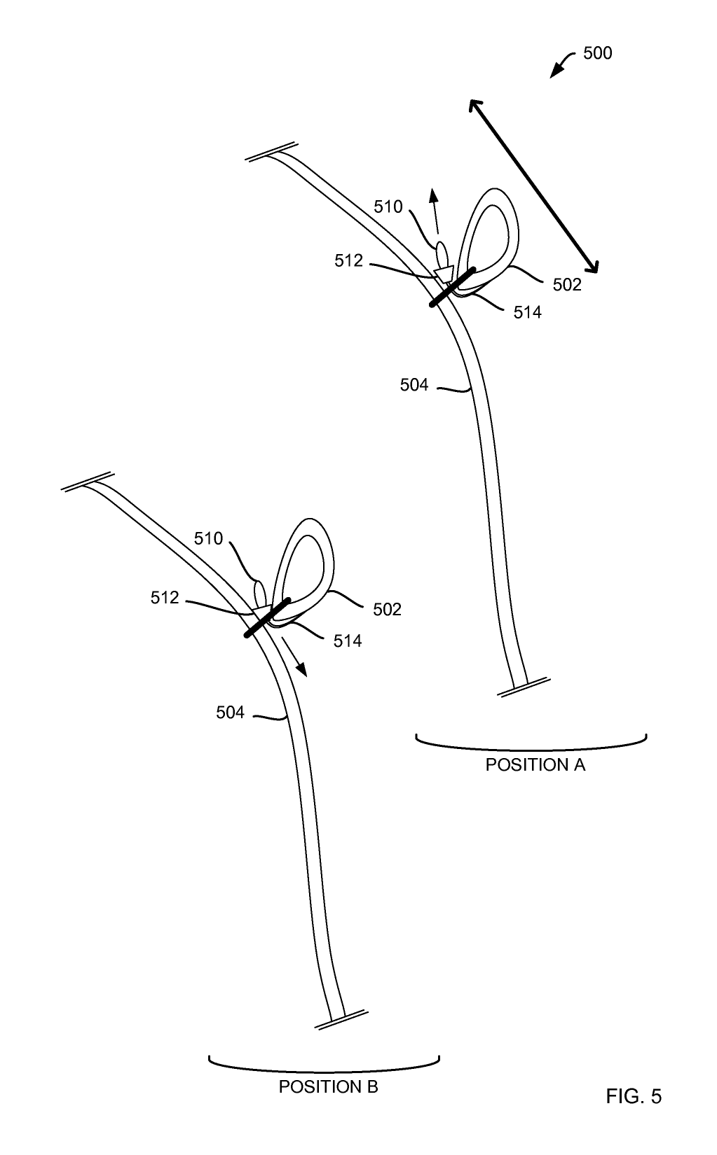

FIG. 5 is an illustrative representation of a leash 500 having a handle cinch arrangement in accordance with embodiments of the present invention. In embodiments, handle cinch arrangements may be configured for temporarily fixing sliding handle 502 at a position along a length of elongated lead 504. It may be appreciated that in some embodiments, it may be desirable to temporarily fix the position of a sliding handle in order to more effectively control an animal. In some examples, fixing the position of the sliding handle effectively shortens the length of the leash. In embodiments, handle cinch arrangements include tapered stopper element 512 configured to provide frictional contact between elongated lead 504 and sliding handle 502. Embodiments further include tension element 514 for drawing tapered stopper element 512 against elongated lead 504 and sliding handle 502. In some embodiments, tension elements may include: a length of shock cord, a length of bungee cord, and an elastic cable. Embodiments further include release element 510 for drawing tapered stopper element 512 away from elongated lead 504 and sliding handle 502. As illustrated, when leash is in position A, sliding handle 502 may be freely moved along elongated lead 504. When leash is in position B, sliding handle 502 is temporarily affixed to a position on elongated lead 504 by handle cinch arrangement. It may be appreciated that any cinching arrangement known in the art may be utilized without departing from embodiments described herein. For example, in some embodiments, spring loaded cam devices may be utilized without limitation.

FIG. 6 is an illustrative representation of lower slide stops in accordance with embodiments of the present invention. In embodiments, leash 600 may include any number of types of slides stops for temporarily securing sliding handle 604 with respect to collar attachment mechanism 606. In one embodiment lower slide stop 610 may include a multifold arrangement 612 of elongated strap. Multifold arrangements, as contemplated herein, include at least two folds of an elongated lead where the folds are folded back alone the elongated lead to create a slide stop. Advantageously, a slide stop utilizing a multifold arrangement provides for a sliding arrangement to move in one direction of pull freely, while providing a stop for a sliding arrangement in an opposite direction of pull. As such, sliding handles may be moved freely toward collar attachment mechanisms along elongated leads, whereupon, once past lower slide stops, sliding handles may be temporarily secured proximal to collar attachment mechanisms. Multifold arrangements may be secured welding, gluing, taping, sewing, bolting, riveting, screwing, or any other manner known in the art without departing from embodiments herein.

In another embodiment lower slide stop 620 may include a tapered stop arrangement 622 mechanically coupled with elongated lead by fastening element 624. In some embodiments, tapered stop arrangements may be located on both sides of elongated strap (not shown). In embodiments tapered stop arrangements are configured to allow free movement in only one direction along an elongated lead. As such, sliding handles may be moved freely toward collar attachment mechanisms along elongated leads, whereupon, once past lower slide stops, sliding handles may be temporarily secured proximal to collar attachment mechanisms. In some embodiments, fastening elements may include bolts, rivets, screws and any other fastening element known in the art. In some embodiments, stop elements may be bonded with elongated leads by welding, gluing, taping, sewing, or any other method known in the art without departing from embodiments provided herein.

In yet another embodiment lower slide stop 630 may include a hook 634 and flap 632 stop arrangement mechanically coupled with elongated lead by fastening element 636. In some embodiments, hook and flap stop arrangements may be located on both sides of elongated strap (not shown). In embodiments hook and flap stop arrangements are configured to allow free movement in only one direction along an elongated lead. As such, sliding handles may be moved freely toward collar attachment mechanisms along elongated leads, whereupon, once past lower slide stops, sliding handles may be temporarily secured proximal to collar attachment mechanisms. In some embodiments, fastening elements may include bolts, rivets, screws and any other fastening element known in the art. In some embodiments, stop arrangements may be bonded with elongated leads by welding, gluing, taping, sewing, or any other method known in the art without departing from embodiments provided herein.

Any number of intermediate slide stops (not shown) may be utilized in accordance with embodiments herein. Intermediate slide stop embodiments may function similarly as lower slide stop embodiments described above. Thus, a leash may be configured to provide multiple lengths corresponding with intermediate slide stops appropriate to a required level of control.

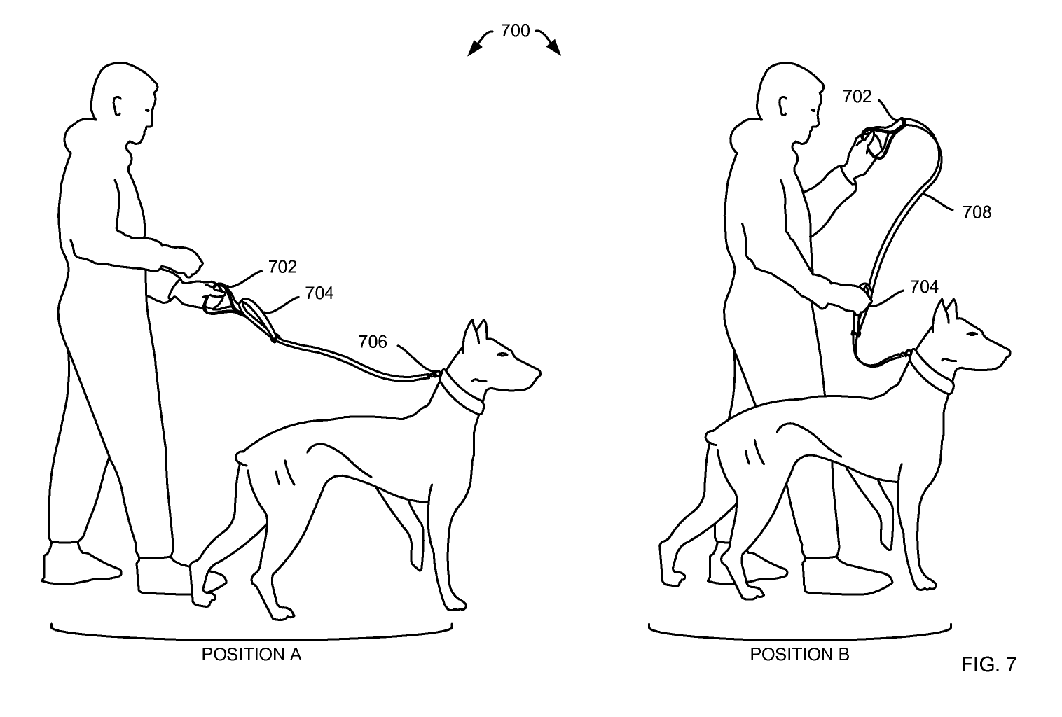

FIG. 7 is an illustrative representation of a leash in use 700 in accordance with embodiments of the present invention. As illustrated, a handler in position A may utilize leash embodiments as in typical fixed length leashes. In particular a handler may attach leash to an animal having a collar at collar attachment mechanism 706. Handler may then utilize fixed handle 702 to control an animal in a conventional way. As illustrated in position A, sliding handle 704 may be affixed proximate to fixed handle 702. As may be appreciated, in embodiments, sliding handle 704 may be configured with an open loop utilizing semi-rigid members as described above. Further as noted above, an open loop configuration may be useful in keeping sliding handle easily accessible to a handler. In order to more effectively control an animal as illustrated in position B, a handler may grasp sliding handle 704 and move sliding handle 704 along the length of the elongated lead toward the animal thus effectively shortening the leash. In some embodiments, a handler may temporarily securing sliding handle 704 below a lower slide stop. Importantly, handler may also continue to exert a force using fixed handle 702 to maintain a shortened leash. When close control is no longer required, a handler may re-affix sliding handle 704 proximate to fixed handle 702. In some embodiments, sliding handle 704 may be temporarily secured at an intermediate position along the length of an elongated lead utilizing a handle cinch arrangement or intermediate slide stop as described above. When sliding handles are temporarily affixed, a handler may then control an animal with a single hand.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A leash comprising:
an elongated lead having, a proximal end portion, a distal end portion and a length defined there between;
a fixed handle disposed at the proximal end portion, wherein the fixed handle is constructed and arranged to receive a handler's first hand;
a collar attachment mechanism disposed at the distal end portion; and
a sliding handle slidingly attached along the length of the elongated lead thereof by a sliding mechanism such that the sliding handle is configured to freely move along the length of the elongated lead, wherein the sliding handle is configured to maintain an open loop, the open loop arranged to receive a handler's second hand.

2. The leash of claim 1, further comprising:
a holding element disposed proximate to the fixed handle along the length of the elongated lead for temporarily affixing the sliding handle proximate to the fixed handle; and
an upper slide stop disposed proximately with the holding element along the length of the elongated lead configured to align the sliding handle with the holding element.

3. The leash of claim 2, wherein the holding element is selected from the group consisting of: a hook and loop arrangement, a VELCRO™ arrangement, a snap arrangement, a magnetic strip arrangement, and a clasping arrangement.

4. The leash of claim 2, wherein the upper slide stop is selected from the group consisting of a multifold arrangement, a button arrangement, and a washer arrangement.

5. The leash of claim 1 further comprising:
a lower slide stop disposed proximately with the collar attachment mechanism along the length of the elongated lead configured to temporarily secure the sliding handle proximate to the collar attachment mechanism.

6. The leash of claim 1 further comprising:
an intermediate slide stop disposed along the length of the elongated lead configured to temporarily secure the sliding handle in an intermediate position along the elongated lead.

7. The leash of claim 6, wherein the lower slide stop and the intermediate stop are selected from the group consisting of: a multifold arrangement, a tapered stop arrangement, and a hook and flap arrangement.

8. The leash of claim 1 wherein the open loop is maintained by one of the group consisting of at least one semi-rigid member and a chemical stiffening agent.

9. The leash of claim 1, wherein the collar attachment mechanism includes a swivel arrangement for allowing the collar to freely rotate with respect to the elongated lead.

10. The leash of claim 1, wherein the leash is manufactured from a material selected from the group consisting of: a natural fiber strap, a polymeric fiber strap, a leather strap, a natural fiber rope, a polymeric rope, a leather rope, a metal rope, a cable, a natural fiber hollow tube strap, a polymeric fiber hollow tube strap and a metal chain.

11. The leash of claim 1, wherein sliding mechanism is a ring, the ring having an annular shape selected from the group consisting of a circular shape, an ovate shape, a semi-ovate shape, a triangular shape, a rectangular shape, and a semi-rectangular shape.

12. A leash comprising:
an elongated lead having, a proximal end portion, a distal end portion and a length defined there between;
a fixed handle disposed at the proximal end portion, wherein the fixed handle is constructed and arranged to receive a handler's first hand;
a collar attachment mechanism disposed at the distal end portion;
a sliding handle slidingly attached along the length of the elongated lead thereof by a sliding mechanism such that the sliding handle is configured to freely move along the length of the elongated lead, wherein the sliding handle includes at least one semi-rigid member configured to maintain an open loop, the open loop arranged to receive a handler's second hand;
a holding element disposed proximate to the fixed handle along the length of the elongated lead for temporarily affixing the sliding handle proximate to the fixed handle;
an upper slide stop disposed proximately with the holding element along the length of the elongated lead configured to align the sliding handle with the holding element; and
a lower slide stop disposed proximately with the collar attachment mechanism along the length of the elongated lead configured to temporarily secure the sliding handle proximate to the collar attachment mechanism.

13. The leash of claim 12 further comprising:
an intermediate slide stop disposed along the length of the elongated lead configured to temporarily secure the sliding handle in an intermediate position along the elongated lead.

14. The leash of claim 12, wherein the holding element is selected from the group consisting of: a hook and loop arrangement, a VELCRO™ arrangement, a snap arrangement, a magnetic strip arrangement, and a clasping arrangement.

15. The leash of claim 12, wherein the upper slide stop is selected from the group consisting of: a multifold arrangement, a button arrangement, and a washer arrangement.

16. The leash of claim 12, wherein the lower slide stop and the intermediate stop are selected from the group consisting of a multifold arrangement, a tapered stop arrangement, and a hook and flap arrangement.

17. A method of utilizing a leash comprising:
attaching an animal to the leash, wherein
the animal is attached to the leash by a collar attachment mechanism, wherein
the collar attachment mechanism is attached at a distal end portion of an elongated lead of the leash, and wherein
the collar attachment mechanism includes a swivel arrangement for allowing the collar to freely rotate with respect to the elongated lead
handling the animal utilizing a fixed handle disposed at a proximal end portion of the elongated lead and constructed and arranged to receive a handler's first hand; and
closely controlling the animal by grasping a sliding handle initially disposed at the proximal end portion and moving the sliding handle to the distal end portion such that the animal is closely controlled by a handler, wherein,
the sliding handle is configured to freely move along the elongated lead, and
wherein
the sliding handle is configure to maintain an open loop.

18. The method of claim 17, further comprising:
temporarily securing the sliding handle proximate to the collar attachment mechanism by moving the sliding handle past a lower slide stop, wherein the lower slide stop is configured to allow the sliding handle to move freely toward the collar attachment mechanism and to temporarily secure the sliding handle from moving toward the fixed handle.

19. The method of claim 18 further comprising:
temporarily affixing the sliding handle proximate to the fixed handle by moving the sliding handle toward the fixed handle to an upper slide stop and affixing the sliding handle to a holding element disposed proximate to the fixed handle.

20. The method of claim 17, further comprising:
temporarily securing the sliding handle in an intermediate position along the elongated lead by moving the sliding handle along the elongated lead past an intermediate slide stop, wherein the intermediate slide stop is configured to allow the sliding handle to move freely toward the collar attachment mechanism and to temporarily secure the sliding handle from moving toward the fixed handle.
